(19) United States
(12) Patent Application Publication
(10) Pub. No.: US 2009/0083787 A1
(43) Pub. Date: Mar. 26, 2009

(54) Pivotable Events Timeline

(75) Inventor: Ronald A. Morris, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/858,854

(22) Filed: Sep. 20, 2007

(51) Int. Cl. H04N 7/025; H04N 7/173

(52) U.S. Cl. 725/32; 725/105

(57) ABSTRACT

A pivotable events timeline is described. In embodiment(s), a pivotable events timeline can include event indicators of events associated with television media content. The event indicators can be displayed to indicate a sequence of the events along the pivotable events timeline. An event on the pivotable events timeline can be expanded when an event indicator corresponding to the event is selected. The selected event can be expanded to display information associated with the event and/or the television media content.

### BACKGROUND

Viewers have an ever-increasing selection of television programming and on-demand choices from which to choose from, and may want to locate programming and movie choices that are of interest to them. In addition to the scheduled television program broadcasts, viewing options also include the on-demand choices (e.g., movies) which enable a viewer to search for and request media content for viewing when convenient rather than at a scheduled broadcast time. Typically, a viewer can initiate a search for television programming choices and/or on-demand viewing choices in a program guide (also commonly referred to as an electronic program guide or “EPG”).

A typical program or movie description shown in a program guide merely provides a short plot description, rating information, a list of some cast members, or other information associated with the media content. The other associated information can include metadata that is used to describe and categorize the media content. However, the simple program and movie descriptions rarely provide enough information for a viewer to decide whether a program or movie will be of interest to them.

In addition, conventional program search interfaces for television (e.g., a program guide) do not provide a technique to locate and track related television programs, such as all of the sporting events for the Olympics over the several days that the events are contested. Conventional program search interfaces also do not provide a technique to locate or view an entire season of contests for one sport, such as football, or a particular team throughout a season of the sport, or the career of a player in the particular sport.

### SUMMARY

This summary is provided to introduce simplified concepts of a pivotable events timeline. The simplified concepts are further described below in the Detailed Description. This summary is not intended to identify essential features of the claimed subject matter, nor is it intended for use in determining the scope of the claimed subject matter.

In embodiment(s), a pivotable events timeline can include event indicators of events associated with television media content. The event indicators can be displayed to indicate a sequence of the events along the pivotable events timeline. An event on the pivotable events timeline can be expanded when an event indicator corresponding to the event is selected. The selected event can be expanded to display information associated with the event and/or the television media content. In another embodiment, multiple pivotable events timelines can be displayed together where the multiple pivotable events timelines each correspond to a different television program.

In other embodiment(s), a pivotable events timeline can represent one television program or can represent a group of related television programs. Each of the event indicators on a pivotable events timeline that represents a group of related television programs can each correspond to a different one of the related television programs. For example, a group of related television programs can be a season of sporting contests for a particular sport, and each event indicator corresponds to a different one of the sporting contests. Alternatively, the group of related television programs can a season of sporting contests for a particular team associated with the sport, and each event indicator corresponds to a different one of the sporting contests for the particular team.

### BRIEF DESCRIPTION OF THE DRAWINGS

Embodiments of a pivotable events timeline are described with reference to the following drawings. The same numbers are used throughout the drawings to reference like features and components:

FIG. 1 illustrates an example system in which embodiments of various pivotable events timelines can be implemented.

FIG. 2 illustrates another example system in which embodiments of various pivotable events timelines can be implemented.

FIG. 3 illustrates example method(s) for various embodiments of a pivotable events timeline.

FIG. 4 illustrates various components of an example device which can implement embodiments of a pivotable events timeline.

FIG. 5 illustrates various devices and components in an example entertainment and information system in which embodiments of a pivotable events timeline can be implemented.

### DETAILED DESCRIPTION

Embodiments of a pivotable events timeline provide a mechanism for event driven viewing where a viewer can select and view metadata and other associated information of a time-based event, television program, and/or other media content. A pivotable events timeline can include event indicators of events associated with television media content, and provides an adjustable granularity of the television media content. A viewer can zoom-in, zoom-out, or otherwise expand a pivotable events timeline to view a larger time frame and multiple events. A viewer can also switch between the events and/or pivot on a singular element to reorder the horizontal axis of the pivotable events timeline based on new criteria.

While features and concepts of the described systems and methods for a pivotable events timeline can be implemented in any number of different environments, systems, and/or various configurations, embodiments of a pivotable events timeline are described in the context of the following example systems and environments.

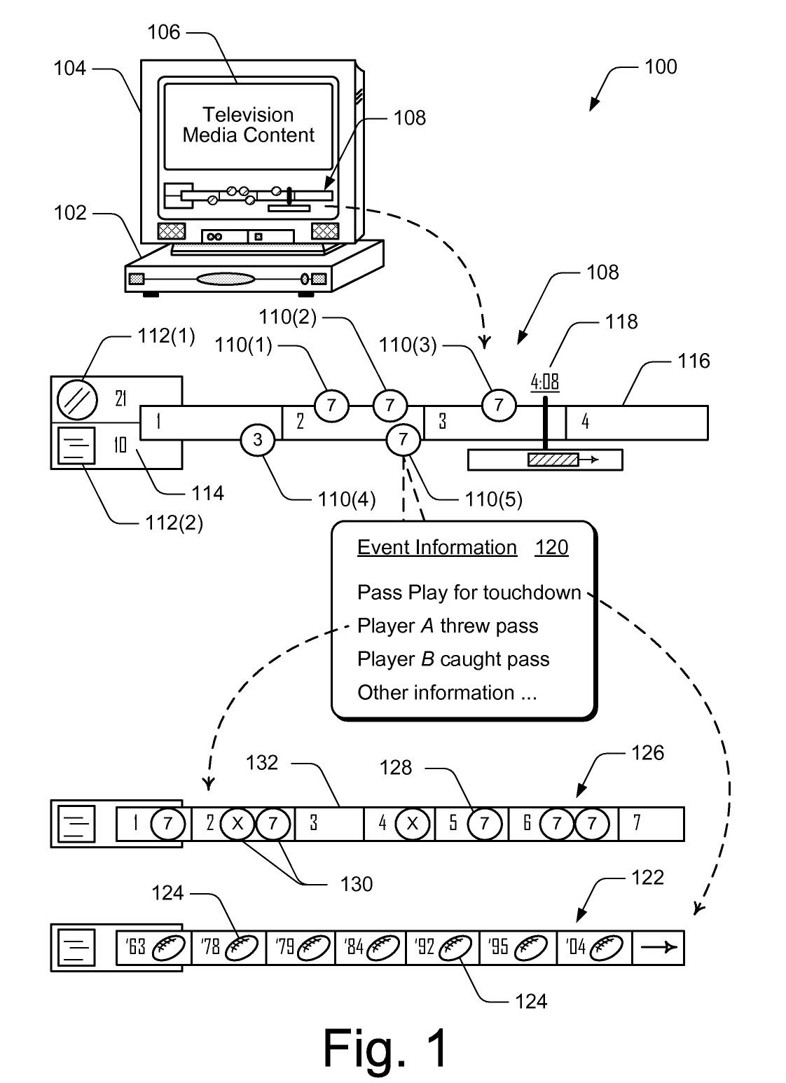

FIG. 1 illustrates an example system 100 in which various embodiments of pivotable events timelines can be implemented. In this example, system 100 includes a television client device 102 and a display device 104. The client device 102 and display device 104 together are an example of a television client system that renders audio, video, and/or image data. The display device 104 can be implemented as any type of television, LCD, or similar display system to display television media content 106 and an associated pivotable events timeline 108.

A pivotable events timeline can be implemented to provide an interface by which a viewer can select and view metadata and other associated information of a time-based event, television program, and/or other media content. As described throughout, “media content” can include television programs (or programming) which may be any form of programs, commercials, music, movies, and video-on-demand media content. Other media content can include interactive games, network-based applications, and any other audio, video, and/or image content (e.g., to include program guide application data, user interface data, search results and/or recommendations, and the like).

A pivotable events timeline provides an adjustable granularity that allows a user to view an event, television program, and/or other media content on different time scales. A pivotable events timeline also provides event driven viewing and the ability to zoom-in, zoom-out, or expand the timeline to view a larger time frame and multiple events. A viewer can also switch between the events and/or to pivot on a singular element (e.g., a particular player or an extraordinary play) and reorder the horizontal axis of the pivotable events timeline to that new criteria.

In the example system 100, the pivotable events timeline 108 is representative of a sporting event contest, such as a football game (e.g., the television media content 106). A pivotable events timeline can include various event indicators of events associated with the television media content. In an embodiment, the event indicators can be displayed to indicate a sequence of the events along the pivotable events timeline. In this example, the pivotable events timeline 108 includes various event indicators 110(1-5) of events associated with the football game, such as plays that result in a score. The pivotable events timeline 108 can include logos 112(1-2) of the two teams participating in the football game, and a score 114 of the contest. Here, the team represented by logo 112(1) is winning the football game by a score of twenty-one to ten.

The event indicators on the pivotable events timeline 108 can also be displayed to indicate additional information about the television media content 106. For example, the event indicators 110(1-5) each indicate a scoring event for one of the two football teams. The team represented by logo 112(1) has a score of twenty-one points which corresponds to event indicators 110(1-3) that each indicate a scoring play (e.g., a touchdown) resulting in seven points for each score. Similarly, the team represented by logo 112(2) has a score of ten points which corresponds to event indicators 110(4-5) that each indicate a scoring play resulting in three points and seven points, respectively.

The example pivotable events timeline 108 is also divided into four units 116 that each indicate a quarter of the football game. Additionally, the event indicators 110(1-5) are positioned within the respective unit for the quarter of the game in which a scoring event occurred. For example, the team represented by logo 112(1) scored a touchdown in the third quarter as indicated by event indicator 110(3). The pivotable events timeline 108 also includes an indication 118 of the progress of the sporting event which is shown as “4:08” (i.e., four minutes and eight seconds) to play in the third quarter of the game.

The pivotable events timeline 108 also provides a representation of the football game because the event indicators 110(1-5) are positioned to communicate information to a viewer that otherwise is not available, such as from a typical box score. In addition, the pivotable events timeline 108 and/or the event indicators 110(1-5) can be color coded for each team to show offensive possessions (e.g., for a football game), which team's batter was up to bat (e.g., for a baseball game), and the like.

A viewer can select any one of the event indicators 110(1-5) that corresponds to an event (e.g., a scoring play) of the football game to view information associated with the event. For example, a viewer may select event indicator 110(5) and client device 102 initiates generating a display of event information 120 that is related to the selected event. For a football game, the event information 120 related to an event can include an indication as to how the points were scored (e.g., a “pass play” or a “run play”), an indication of the player who threw the pass, an indication of the player who caught the pass, and/or any other type of event related information.

A viewer can also select from the event information 120 to further expand the information associated with a particular selected event. For example, a viewer may select the “Pass Play” information to initiate a pivotable events timeline 122 that includes event indicators 124 from which the viewer may select and initiate for viewing the all-time best pass plays in football history. The pivotable events timeline 122 also includes indications of the seasons (e.g., years) in which each of the best pass plays occurred, such as in “1978”, “1992”, and the like. In an embodiment, the pivotable events timeline 122 can replace the pivotable events timeline 108 on display device 104 and the television media content 106 would display as the corresponding video highlights of the all-time best pass plays in football history.

Alternatively, a viewer may select the “Player A” information to initiate a pivotable events timeline 126 that includes event indicators 128, 130 from which the viewer may select and initiate for viewing the video highlights of “Player A” throughout the first seven games of the football season. The pivotable events timeline 126 includes units 132 that each represent one of the first seven games of the football season, and the event indicators 128, 130 are displayed proximate the units 132 in which a video highlight occurred. For example, “Player A” had two noteworthy highlights in game two of the football season as indicated by event indicators 130. The “Player A” did not have any highlights in the third game of the season (i.e., identified as unit 132), and has a highlight of a scoring play in game five of the season as indicated by event indicator 128. In an embodiment, the pivotable events timeline 126 can replace the pivotable events timeline 108 on display device 104 and the television media content 106 would display as the corresponding video highlights that include “Player A”.

As an alternative to a viewer selecting an event indicator 110(5) that initiates the display of event information 120, a selection of any of the event indicators 110(1-5) may initiate an additional pivotable events timeline or any type of a new display. A new display can include the event expanded to display information associated with the event, information associated with the television media content, and/or information associated with different television media content. For example, each of the pivotable events timelines 122 and 126 are associated with television media content other than the particular football game (e.g., television media content 106). Additionally, any of the pivotable events timelines described herein can include event indicators that correspond to any events of interest for a television program and/or other media content.

Although the pivotable events timeline 108 is described with reference to a football game, other embodiments of various pivotable events timelines can be implemented. For example, a pivotable events timeline can correspond to a season of a sport, where each event indicator represents a different game of the sport within the season. Alternatively, a pivotable events timeline can correspond to a day, week, or month of all the games for a particular sport. A pivotable events timeline may also be implemented for a particular team of a sport, where each event indicator represents a different game of the sport for the particular team.

Additionally, a pivotable events timeline can be implemented to include event indicators that each correspond to an event from different media content. For example, a pivotable events timeline can represent a group of related television programs, such as all of the sports teams (e.g., baseball, football, basketball, hockey, etc.) for a city. Each of the event indicators on a pivotable events timeline can then correspond to a different one of the related television programs that are each of different sports. For example, a viewer could select any of the event indicators on the pivotable events timeline that represents the different sports teams and the television client device 102 can initiate a display of the selected sporting contest for viewing as the television media content 106.

In another example, a pivotable events timeline can represent related television programs such as the different Olympic events for a day, a week, or for all of the events. Each of the event indicators on a pivotable events timeline can then correspond to a different one of the related television programs that are each of different events. For example, a viewer could select any of the event indicators on the pivotable events timeline that represents the Olympics and the television client device 102 can initiate a display of the selected event for viewing as the television media content 106. An additional pivotable events timeline that corresponds to the Olympics may also include event indicators that a viewer can pivot on to view television programs or video highlights of various participants, particular countries, medal ceremonies, and any other type of associated event.

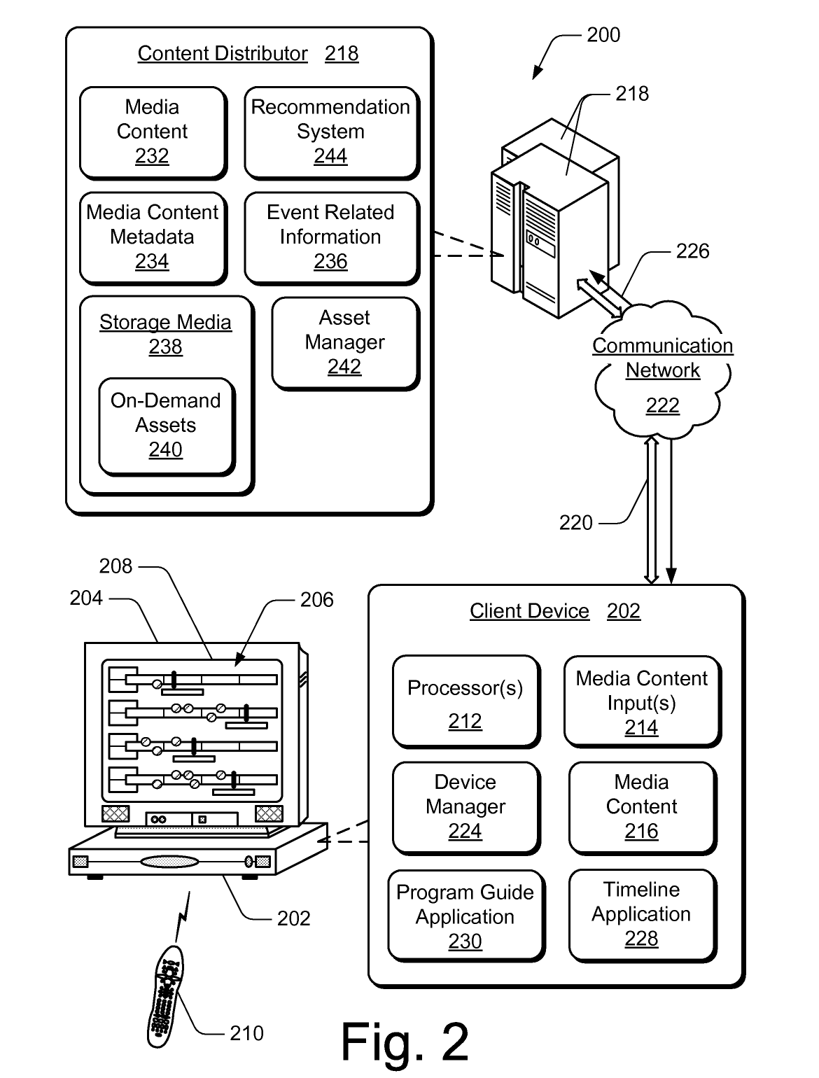

FIG. 2 illustrates an example system 200 in which various embodiments of pivotable events timelines can be implemented. In this example, system 200 includes a television client device 202 and a display device 204 that can display television media content and/or pivotable events timelines 206 on a user interface 208. The multiple pivotable events timelines 206 are displayed together, and in one embodiment, the various pivotable events timelines 206 can each correspond to a different television program (e.g., related sporting events, college education channels, news programs, etc.).

As described in the example above, each of the pivotable events timelines 206 can correspond to different football games that are selectable for viewing on a particular day. A viewer can then quickly switch between the different games that are in progress. A viewer can also adjust the granularity of a pivotable events timeline and expand, zoom-out, or zoom-in to change how the events or associated information is displayed. The event indicators that represent each event can change or stay the same depending on display size as a pivotable events timeline is expanded to display a month, a season, a year, and the like. A viewer can interact with the television client device 202 and initiate selections of event indicators from the pivotable events timelines 206 on the user interface 208 with user inputs on an input device 210, such as a television remote control.

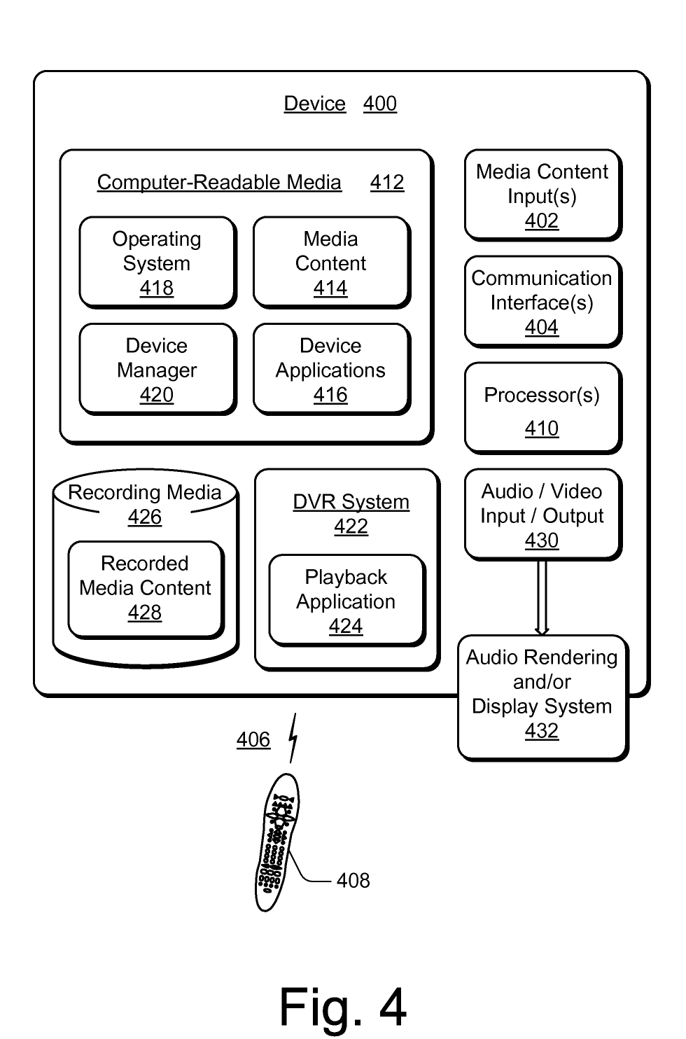

The example client device 202 can be implemented as any one or combination of a television set-top box, a digital video recorder (DVR) and playback system, an appliance device, a gaming console, a portable communication device, a portable computing device, and/or as any other type of television client device or computing-based device that may be implemented in a television entertainment and information system. Additionally, client device 202 can be implemented with any number and combination of differing components as further described with reference to the example device shown in FIG. 4. Client device 202 may also be associated with a user or viewer (i.e., a person) and/or an entity that operates the device such that a client device describes logical clients that include users, software, and/or devices.

In the example system 200, client device 202 includes one or more processors 212 (e.g., any of microprocessors, controllers, and the like), media content inputs 214, and media content 216 (e.g., received media content, media content that is being received, pivotable events timeline data, etc.). The client device 202 can be configured for communication with various content distributor(s) 218 via an IP-based network 220 and/or communication network 222. The media content inputs 214 can include any type of communication interfaces and/or data inputs, such as Internet Protocol (IP) inputs over which streams of television media content (e.g., IPTV media content) are received via the IP-based network 220 and/or communication network 222. The media content inputs 214 can include any type of wireless, broadcast, and/or over-the-air inputs via which media content is received.

The IP-based network 220 can be implemented as part of the communication network 222 that facilitates media content distribution and data communication between the content distributor(s) 218 and any number of client devices, such as client device 202. The communication network 222 can be implemented as part of a media content distribution system using any type of network topology and/or communication protocol, and can be represented or otherwise implemented as a combination of two or more networks.

Client device 202 also includes a device manager 224 (e.g., a control application, software application, etc.) that can be implemented as computer-executable instructions and executed by the processor(s) 212 to implement various embodiments of a pivotable events timeline. The device manager 224 can be implemented to monitor and/or receive selectable inputs (e.g., user selections) via the input device 210, and initiate communication of the viewer selections back to a content distributor 218.

The client device 202 can communicate with a content distributor 218 via a two-way data communication link 226 of the communication network 222. It is contemplated that any one or more of the arrowed communication link 226 and network 220, along with communication network 222, facilitate two-way data communication, such as from client device 202 to a content distributor 218 and vice-versa.

The client device 202 can also include a timeline application 228 and/or a program guide application 230, both of which can be implemented as computer-executable instructions and executed by the processor(s) 212 to implement various embodiments of a pivotable events timeline. In an embodiment, the timeline application 228 can be implemented to process pivotable events timeline data and generate the various pivotable events timelines 206 for display on display device 204. The program guide application 230 can be implemented to process program guide data from which a program guide can be rendered and/or displayed for viewing on display device 204. A program guide may also be commonly referred to as an electronic program guide or an “EPG”. In this example, the user interface 208 that includes the various pivotable events timelines 206 may be rendered as a panel of a program guide interface and/or program search interface.

Although the timeline application 228 and the program guide application 230 are each illustrated and described as single applications (e.g., independent components of client device 202), each can be implemented as several component applications or modules distributed to implement various embodiments of a pivotable events timeline. Alternatively, the timeline application 228 and the program guide application 230 can be implemented together as a multi-functional component of client device 202 to implement embodiments of a pivotable events timeline.

A content distributor 218 can distribute media content 232, media content metadata 234, and/or event related information 236 (e.g., pivotable events timeline data) to any number of television client devices as an IPTV multicast via the IP-based network 220 and/or the communication network 222. The content distributor 218 can also include various components to implement various embodiments of a pivotable events timeline.

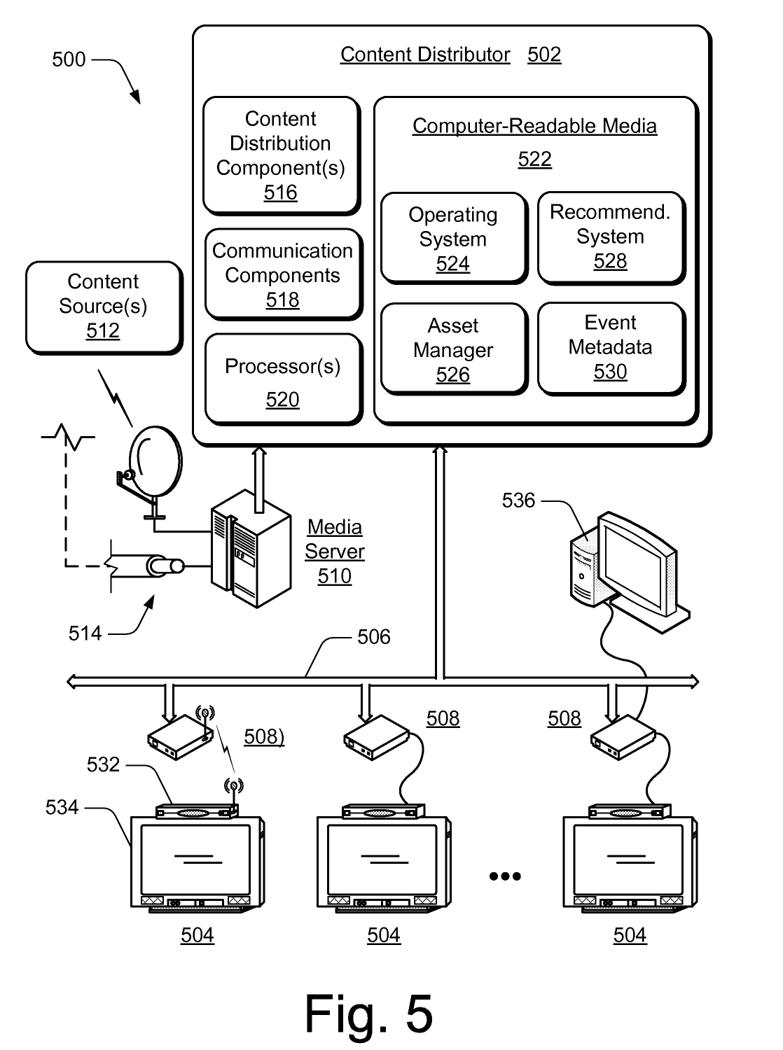

In this example system 200, content distributor 218 includes storage media 238 to store or maintain the media content 232, media content metadata 234, event related information 236, and/or on-demand assets 240 that can be requested by various television client devices. The content distributor 218 can also include an asset manager 242 to manage the assets maintained by the content distributor, such as the media content 232 and the on-demand assets 240. In addition, a content distributor 218 can be implemented with any number and combination of differing components as further described with reference to the example device shown in FIG. 4 and/or the example content distributor shown in FIG. 5.

The content distributor 218 can also include a recommendation system 244 to implement various embodiments of a pivotable events timeline. The recommendation system 244 can include a mapping of the media content metadata 234 and/or event related information 236 as it corresponds to the various media content 232 and/or on-demand assets 240. In an embodiment, the media content metadata 234 and/or the event related information 236 can be generated by data entry, by the recommendation system 244, from closed caption data, and/or by any other system implemented to generate the event information associated with event indicators on a pivotable events timeline.

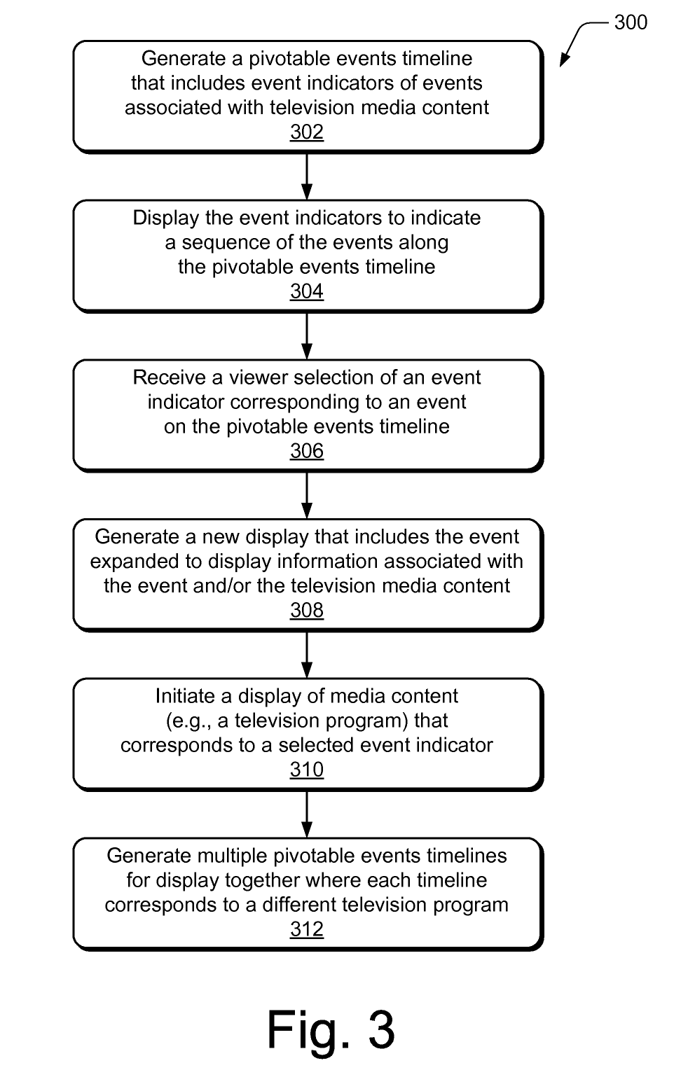

Generally, any of the functions, methods, procedures, and modules described herein can be implemented using hardware, software, firmware (e.g., fixed logic circuitry), manual processing, or any combination thereof. A software implementation of a function, method, procedure, or module represents program code that performs specified tasks when executed on a computing-based processor. Example method 300 described with reference to respective FIG. 3 may be described in the general context of computer-executable instructions. Generally, computer-executable instructions can include applications, routines, programs, objects, components, data structures, procedures, modules, functions, and the like that perform particular functions or implement abstract data types.

The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 for various embodiments of a pivotable events timeline. The order in which the method is described is not intended to be construed as a limitation, and any number of the described method blocks can be combined in any order to implement the method, or an alternate method.

At block 302, a pivotable events timeline is generated that includes event indicators of events associated with television media content. At block 304, the event indicators are displayed to indicate a sequence of the events along the pivotable events timeline. For example, the timeline application 228 (FIG. 2) at client device 202 generates the pivotable events timeline 108 (FIG. 1) for display. The pivotable events timeline 108 includes event indicators 110(1-5) of events associated with television media content 106. In an example, the pivotable events timeline 108 represents a football game and the various event indicators 110(1-5) indicate a sequence of scoring events in the game.

At block 306, a viewer selection of an event indicator corresponding to an event on the pivotable events timeline is received. For example, the device manager 224 at client device 202 receives a viewer selection of an event indicator 110 via the input device 210. A viewer can select any one of the event indicators 110(1-5) that corresponds to an event (e.g., a scoring play) of the football game to view information associated with the event.

At block 308, a new display is generated that includes the event expanded to display information associated with the event and/or the television media content. For example, the timeline application 228 at client device 202 initiates a new display of event information 120 and/or a different pivotable events timeline, such as either of pivotable events timelines 122 or 126. In an embodiment, the information associated with a selected event corresponds to different television media content. In an alternate embodiment, a pivotable events timeline represents a group of related television programs, and each event indicator corresponds to a different one of the related television programs.

At block 310, a display of media content that corresponds to a selected event indicator is initiated. For example, a viewer may select an event indicator 110 on the pivotable events timeline 108 and the television client device 102 can initiate a display of the selected event for viewing as the television media content 106.

At block 312, multiple pivotable events timelines are generated for display together where each pivotable events timeline corresponds to a different television program. For example, multiple pivotable events timelines 206 are displayed together, and in one embodiment, the various pivotable events timelines 206 can each correspond to a different television program (e.g., related sporting events, college education channels, news programs, etc.).

FIG. 4 illustrates various components of an example device 400 that can be implemented as any form of a computing, electronic, appliance, television client device, or television system device to implement various embodiments of a pivotable events timeline. For example, device 400 can be implemented as the television client device shown in FIG. 1, and/or as the television client device or content distributor shown in FIG. 2. In various embodiments, device 400 can be implemented as any one or combination of a television client device, a digital video recorder (DVR), a gaming system or console, a computing-based device, an appliance device, and/or as any other type of similar device.

Device 400 includes one or more media content inputs 402 that may include Internet Protocol (IP) inputs over which streams of media content are received via an IP-based network. Device 400 further includes communication interface(s) 404 that can be implemented as any one or more of a serial and/or parallel interface, a wireless interface, any type of network interface, a modem, and as any other type of communication interface. A network interface provides a connection between device 400 and a communication network by which other electronic and computing devices can communicate data with device 400.

Similarly, a serial and/or parallel interface provides for data communication directly between device 400 and the other electronic or computing devices. A modem also facilitates communication with other electronic and computing devices via a conventional telephone line, a DSL connection, cable, and/or other type of connection. A wireless interface enables device 400 to receive control input commands 406 and other data from an input device, such as from remote control device 408, a portable computing-based device (such as a cellular phone), or from another infrared (IR), 802.11, Bluetooth, or similar RF input device.

Device 400 also includes one or more processors 410 (e.g., any of microprocessors, controllers, and the like) which process various computer-executable instructions to control the operation of device 400, to communicate with other electronic and computing devices, and to implement embodiments of a pivotable events timeline. Device 400 can be implemented with computer-readable media 412, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 412 provides data storage mechanisms to store media content 414, as well as device applications 416 and any other types of information and/or data related to operational aspects of device 400. For example, an operating system 418 can be maintained as a computer application with the computer-readable media 412 and executed on processor(s) 410. The device applications can include a device manager 420 and/or a timeline application when device 400 is implemented as a television client device. The device manager 420 is shown as a software module in this example to implement various embodiments of a pivotable events timeline. An example of the device manager 420 is described with reference to device manager 224, and an example of a timeline application is described with reference to timeline application 228 for client device 202 shown in FIG. 2.

When implemented as a television client device, the device 400 can also include a DVR system 422 with a playback application 424, and recording media 426 to maintain recorded media content 428 that device 400 receives and/or records. The recorded media content 428 can include the media content 414 that is received from a content distributor and recorded. For example, the media content 428 can be recorded when received as a viewer-scheduled recording, or when the recording media 426 is implemented as a pause buffer that records the media content 428 as it is being received and rendered for viewing.

Further, device 400 may access or receive additional recorded media content that is maintained with a remote data store (not shown). Device 400 may also receive media content from a video-on-demand server, or media content that is maintained at a broadcast center or content distributor that distributes the media content to subscriber sites and client devices. The playback application 424 can be implemented as a media control application to control the playback of media content 414, the recorded media content 428, and/or any other audio, video, and/or image media content which can be rendered and/or displayed for viewing.

Device 400 also includes an audio and/or video output 430 that provides audio and/or video data to an audio rendering and/or display system 432. The audio rendering and/or display system 432 can include any devices that process, display, and/or otherwise render audio, video, and image data. Video signals and audio signals can be communicated from device 400 to a display device via an RF (radio frequency) link, S-video link, composite video link, component video link, DVI (digital video interface), analog audio connection, or other similar communication link. Alternatively, the audio rendering and/or display system 432 can be implemented as integrated components of the example device 400.

FIG. 5 illustrates an example entertainment and information system 500 in which various embodiments of a pivotable events timeline can be implemented. System 500 facilitates the distribution of media content, program guide data, and/or advertising content to multiple viewers and viewing systems. System 500 includes a content distributor 502 and any number of client systems 504 each configured for communication via a communication network 506. Each of the client systems 504 can receive data streams of media content, program content, program guide data, advertising content, closed captions data, event metadata, and the like from content server(s) of the content distributor 502 via the communication network 506.

The communication network 506 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 506 can be implemented using any type of network topology and any network communication protocol, and can be represented or otherwise implemented as a combination of two or more networks. A digital network can include various hardwired and/or wireless links 508, such as routers, gateways, and so on to facilitate communication between content distributor 502 and the client systems 504.

System 500 includes a media server 510 that receives content from various content sources 512, such as media content from a content provider, program guide data from a program guide source, and advertising content from an advertisement provider. In an embodiment, the media server 510 represents an acquisition server that receives audio and video content from a provider, an EPG server that receives the program guide data from a program guide source, and/or an advertising management server that receives the advertising content from an advertisement provider.

The content sources, such as the content provider, program guide source, and the advertisement provider control distribution of the media content, the program guide data, and the advertising content to the media server 510 and/or to other servers of system 500. The media content, program guide data, and advertising content can be distributed via various transmission media 514, such as satellite transmission, radio frequency transmission, cable transmission, and/or via any number of other wired or wireless transmission media. In this example, media server 510 is shown as an independent component of system 500 that communicates the program content, program guide data, and advertising content to content distributor 502. In an alternate implementation, media server 510 can be implemented as a component of content distributor 502.

Content distributor 502 is representative of a headend service in a content distribution system, for example, that provides the media content, program guide data, and advertising content to multiple subscribers (e.g., the client systems 504). The content distributor 502 can be implemented as a satellite operator, a network television operator, a cable operator, and the like to control distribution of media content, program and advertising content, such as movies, television programs, commercials, music, and any other audio, video, and/or image content to the client systems 504.

Content distributor 502 includes various content distribution components 516 to facilitate media content processing and distribution, such as a subscriber manager, a device monitor, and one or more content servers. The subscriber manager manages subscriber data, and the device monitor monitors the client systems 504 (e.g., and the subscribers), and maintains monitored client state information.

Although the various managers, servers, and monitors of content distributor 502 (to include the media server 510 in one embodiment) are described as distributed, independent components of content distributor 502, any one or more of the managers, servers, and monitors can be implemented together as a multi-functional component of content distributor 502. Additionally, any one or more of the managers, servers, and monitors described with reference to system 500 can implement features and embodiments of pivotable events timeline.

In this example, the content distributor 502 includes communication components 518 that can be implemented to facilitate media content distribution to the client systems 504 via the communication network 506. The content distributor 502 also includes one or more processors 520 (e.g., any of microprocessors, controllers, and the like) which process various computer-executable instructions to control the operation of content distributor 502. The content distributor 502 can be implemented with computer-readable media 522 which provides data storage to maintain software applications such as an operating system 524, an asset manager 526, and a recommendation system 528. The computer-readable media 522 can also provide data storage to maintain event metadata 530 that corresponds to events represented as event indicators on various pivotable events timelines.

The client systems 504 can each be implemented to include a client device 532 and a display device 534 (e.g., a television, LCD, and the like). A client device 532 of a respective client system 504 can be implemented in any number of embodiments, such as a set-top box, a digital video recorder (DVR) and playback system, an appliance device, a gaming system, and as any other type of client device that may be implemented in an entertainment and information system. In an alternate embodiment, a client system 504 may implemented with a computing device 536 as well as a client device. Additionally, any of the client devices 532 of a client system 504 can implement features and embodiments of pivotable events timeline as described herein.

Although embodiments of pivotable events timeline have been described in language specific to features and/or methods, it is to be understood that the subject of the appended claims is not necessarily limited to the specific features or methods described. Rather, the specific features and methods are disclosed as example implementations of pivotable events timeline.

1. A method, comprising:
generating a pivotable events timeline that includes event indicators of events associated with television media content, the event indicators being displayed to indicate a sequence of the events along the pivotable events timeline;
receiving a viewer selection of an event indicator corresponding to an event on the pivotable events timeline; and
generating a new display that includes the event expanded to display information associated with the event.

2. A method as recited in claim 1, wherein the event indicators are further displayed to indicate additional information about the television media content.

3. A method as recited in claim 1, wherein the new display further includes the event expanded to display additional information associated with the television media content.

4. A method as recited in claim 1, wherein the information associated with the event corresponds to different television media content.

5. A method as recited in claim 1, wherein the pivotable events timeline represents a group of related television programs, and wherein each event indicator corresponds to a different one of the related television programs.

6. A method as recited in claim 5, wherein the group of related television programs includes a season of sporting contests for a particular sport, and wherein each event indicator corresponds to a different one of the sporting contests.

7. A method as recited in claim 5, wherein the group of related television programs includes a season of sporting contests for a particular team associated with a sport, and wherein each event indicator corresponds to a different one of the sporting contests for the particular team.

8. A method as recited in claim 1, wherein the new display is generated as an additional pivotable events timeline that includes the event expanded to display the information associated with the event along the additional pivotable events timeline.

9. A method as recited in claim 1, further comprising generating multiple pivotable events timelines for display together, the multiple pivotable events timelines each corresponding to a different television program.

10. A television client device, comprising:
a media content input configured to receive television media content for display;
a timeline application configured to generate a pivotable events timeline that includes event indicators of events associated with the television media content; and
a device manager configured to receive a viewer selection of an event indicator that corresponds to an event on the pivotable events timeline, and further configured to initiate that the timeline application expand the event to display information associated with the event.

11. A television client device as recited in claim 10, wherein the event indicators are displayed along the pivotable events timeline to indicate additional information about the television media content.

12. A television client device as recited in claim 10, wherein the timeline application is further configured to expand the event to display additional information associated with the television media content.

13. A television client device as recited in claim 10, wherein the timeline application is further configured to expand the event to display additional information associated with different television media content.

14. A television client device as recited in claim 10, wherein the timeline application is further configured to generate the pivotable events timeline to represent a group of related television programs, and wherein each event indicator corresponds to a different one of the related television programs.

15. A television client device as recited in claim 10, wherein the timeline application is further configured to generate multiple pivotable events timelines for display together, the multiple pivotable events timelines each corresponding to a different television program.

16. One or more computer-readable media comprising computer-executable instructions that, when executed, direct a television client device to:
generate a pivotable events timeline that includes event indicators of events associated with television media content, the event indicators being displayed to indicate a sequence of the events along the pivotable events timeline; and
expand an event on the pivotable events timeline when an event indicator corresponding to the event is selected, the event being expanded to display information associated with the event.

17. One or more computer-readable media as recited in claim 16, further comprising computer-executable instructions that, when executed, direct the television client device to expand the event to display additional information corresponding to different television media content.

18. One or more computer-readable media as recited in claim 16, further comprising computer-executable instructions that, when executed, direct the television client device to generate multiple pivotable events timelines for display together, the multiple pivotable events timelines each corresponding to a different television program.

19. One or more computer-readable media as recited in claim 16, further comprising computer-executable instructions that, when executed, direct the television client device to generate the pivotable events timeline to represent a group of related television programs, and wherein each event indicator corresponds to a different one of the related television programs.

20. One or more computer-readable media as recited in claim 16, further comprising computer-executable instructions that, when executed, direct the television client device to generate an additional pivotable events timeline to expand the event and display the information associated with the event.
